(19) United States
(12) Patent Application Publication
(10) Pub. No.: US 2023/0144180 A1
(43) Pub. Date: May 11, 2023

(54) METHOD FOR THE SAFE TRANSFER OF DATA

(71) Applicant: MOBUYOU B.V., OISTERWIJK (NL)

(72) Inventors: Petrus Joannes Wilhelmus VAN HERP, TILBURG (NL); Johannes Hermanus Petrus Maria OONK, TILBURG (NL)

(21) Appl. No.: 17/917,882

(22) PCT Filed: Apr. 9, 2021
(86) PCT No.: PCT/NL2021/050235

§ 371 Date: Oct. 7, 2022

(30) Foreign Application Priority Data
Apr. 10, 2020 (NL) 2025327

(51) Int. Cl. G06Q 20/38; G06Q 20/02; G06Q 20/40

(52) U.S. Cl. CPC G06Q 20/382; G06Q 20/02; G06Q 20/385; G06Q 20/389; G06Q 20/4014

(57) ABSTRACT

The present invention relates to a method and a system for the safe transfer of data between at least two computer devices. In first aspect, the invention to this end provides a method for performing an electronic transaction between a mobile communication device of a buyer, a terminal of a merchant and a transaction server which is connected to the terminal, which mobile communication device, the terminal and the transaction server are comprised in a data network, the method comprising the following steps: the mobile communication device initiates a communication session with the transaction server via the terminal; the transaction server of the mobile communication device receives an identification code which is linked to the buyer; the transaction server initiates a communication session with a trusted third party; the transaction server retrieves buyer-identification information and transaction data from the trusted third party in order to perform the electronic transaction between the buyer and merchant; the transaction server authenticates the buyer on the basis of the received buyer-identification information; the transaction server processes the electronic transaction between the buyer and merchant; furthermore comprising the following steps: the mobile communication device transmits an expiration parameter to define a life span of the buyer-identification information on the transaction server together with the identification code to the transaction server; the transaction server automatically removes the buyer-identification information after the life span of the transaction server determined by the expiration parameter has expired.

The present invention relates to a method and a system for the safe transfer of data between at least two computer devices.

Nowadays, more and more information is being stored, made available and shared in digital form. At least a significant part of the shared and stored information relates to privacy-sensitive information. In this case, in the context of the present application, this may involve information which relates to a person and in particular information which relates to an identified or identifiable natural person. This means that this information is either direct privacy-sensitive information because it discloses direct information about a certain natural person or that this information can indirectly be traced to that person. Examples thereof are email addresses, telephone numbers, passport photos, bank details, address details, etc. This information may also comprise information which does not relate to a natural person, but to organization. Examples thereof are bank details and address details of a company, but also the financial position of an institution may be regarded as privacy-sensitive information in this context.

Because in the current digital era, this information is being used more often and in more locations nowadays, the controllability of this information becomes an increasingly large challenge. In this context, authorities are taking measures in order to counteract the negative consequences thereof. In this case, consideration may be given to the reporting obligation for data leaks, which obliges organizations to report instances of data having been leaked or if there are strong indications that such a leak of data has taken place. Such measures not only aim to ensure the protection of personal data, but also to safeguard the free flow of data.

In certain applications, putting such a reporting obligation for data leaks and other data-protection measures into operation creates challenges with respect to the implementation of new services. An example thereof are digital transactions in which products or services are bought or purchased and in which at least the actual transaction, being the transfer of ownership, making a payment or accepting an agreement, is performed digitally. In order to ensure that such digital transactions are performed in a safe and efficient manner, it is necessary to exchange data relating to the natural persons and organizations which are connected to the transaction as actors. When transferring information, it is at least necessary for the person/persons and organization(s) to be identifiable. Storage and transfer of such information brings responsibilities for the organization which facilitates this storage and transfer to ensure that this data is protected against access by unauthorized persons.

It is currently known to protect such data during storage and transfer against such access by unauthorized persons by using digital protection means such as encryption. However, this has various drawbacks. Encryption requires additional operations which, on the one hand, lay down conditions with regard to the presence of technical measures to perform such an encryption. On the other hand, such additional operations also require a substantial additional amount of processor and memory resources. In addition, encryption still always ensures that the information is transferred, and thus it is the responsibility of the receiving party to carefully manage and protect the received (privacy-sensitive) information, despite the fact that the transfer is safe due to the use of encryption.

It is now an object of the invention to offer a solution to the drawbacks mentioned.

In a first aspect, the object is achieved by a method for performing an electronic transaction between a mobile communication device of a buyer, a terminal of a merchant and a transaction server which is connected to the terminal, which mobile communication device, the terminal and the transaction server are comprised in a data network, the method comprising the following steps:

the mobile communication device initiates a communication session with the transaction server via the terminal;

the transaction server of the mobile communication device receives an identification code which is linked to the buyer;

the transaction server initiates a communication session with a trusted third party;

the transaction server retrieves buyer-identification information and transaction data from the trusted third party in order to perform the electronic transaction between the buyer and merchant;

the transaction server authenticates the buyer on the basis of the received buyer-identification information;

the transaction server processes the electronic transaction between the buyer and merchant; furthermore comprising the following steps:

the mobile communication device transmits an expiration parameter to define a life span of the buyer-identification information on the transaction server together with the identification code to the transaction server;

the transaction server automatically removes the buyer-identification information after the life span of the transaction server determined by the expiration parameter has expired.

As the number of electronic operations increases, so does the number of electronic transactions. In an absolute sense, it is therefore becoming increasingly important for such transactions to be performed in a safe and reliable manner. In the course of such transactions, not only is transaction data transferred, but also information about the buyer which can be traced back directly or indirectly to his or her identity. Such personal and privacy-sensitive information has to be handled very carefully.

Within the context of this document, transaction data are understood to mean those data which relate directly to the electronic transaction and are necessary in order to be able to perform the transaction, this includes the amount (if it is agreed that an amount has to be paid), a source from which the amount has to be debited and a destination to which the amount has to be credited. This source and these destinations may be IBAN account numbers, but also wallets which are coupled to hard currencies, and/or to digital currency units, such as crypto currencies. Therefore, within the context of this document, keys, email addresses and other account identities come under this definition. Within the context of this document, buyer-identification is understood to mean all information which can be traced back directly or indirectly to the buyer. In some cases, this may partly regard the transaction data. For in some cases, the identity of the buyer may be coupled to an account number or wallet.

The invention provides a safe and reliable transaction to perform an electronic transaction between a mobile communication device of a buyer, a terminal of a merchant and a transaction server which is connected to the terminal. In order to perform the transaction, three devices are therefore involved and as a matter of fact also three parties, i.e. a buyer, a merchant or seller, and a transaction-facilitating party. All three are completely or partly wirelessly connected to each other by means of a data network. The buyer uses a mobile communication device, such as a smartphone. The merchant has a (payment) terminal to facilitate the transaction locally. This may be a dedicated payment device, but also a smartphone with an application or a cash register system. The terminal establishes a connection, via the data network, with a transaction server which is situated some distance away, for example in a datacenter.

The mobile communication device establishes the connection with the transaction server via the terminal. This may be effected by means of a public data network such as a local Wi-Fi connection, or via a cellular 3G/4G/5G etc. connection, but it may also be effected via a personal area network, PAN, such as a Bluetooth or RFID connection. When the connection is initiated, a communication session is established between the mobile communication device of the buyer on the one hand, and the transaction server on the other hand. In this case, the terminal facilitates and thus it is also possible to determine where the buyer is situated and thus with whom (which merchant) he or she wants to engage in a transaction. The transaction server receives a code from the mobile communication device by means of which the mobile communication device can be identified. This does not necessarily mean that the buyer can also be traced as a result thereof. This is facilitated, for example, by an irreversibly encrypted code or hash. This is used by the transaction server to retrieve the real identity of the user from a trusted third party. This may be a party which is designated as being trusted and which only manages online identities, such as a certificate authority, but it may also be a party which facilitates the management of (transaction-related) identities, examples of which include banks or a chamber of commerce.

The buyer trusts the management of his or her identity by the third party, since he or she has agreed thereto beforehand and the party is designated as a trusted party. However, doubts may arise before the transaction with the merchant whether the buyer wants to share his or her identity data with this third party. Such privacy-sensitive information may possibly be misused or may not be safe with the merchant. The buyer has not designated the merchant as a trusted third party. In addition, the buyer does not have the option of testing the merchant with regard to the degree to which the merchant is able to manage data safely.

The present invention offers a solution to this problem by only making the personal data available to the merchant for a limited period of time/temporarily. Specifically, the mobile communication device of the buyer can set an expiration parameter by means of an identification code which determines how long the personal data (buyer identification) of the buyer can remain on the transaction server. After the timer has lapsed, the data will automatically be removed. This has the significant advantage that it allows the buyer to determine that the data may only be used during the time of using of the actual transaction. This greatly reduces misuse of data. By setting the expiration parameter in such a way that it equals the period for performing the transaction, the merchant will not be able to re-use or misuse these data and the risk of a data leak is greatly reduced.

In addition, this will also greatly reduce the responsibilities of the merchant, as keeping the buyer identification in his or her possession would be accompanied by data protection-related requirements. If the data are not or no longer managed by the merchant or are no longer accessible, these requirements will then also become obsolete.

Embodiments according to the present invention will be described below.

In one embodiment, the expiration parameter is encrypted by the mobile communication device of the buyer.

This has the advantage that the merchant or an undesired third party is prevented from being able to manipulate the expiration parameter, as a result of which the buyer identification would remain on the transaction server for an unnecessarily long amount of time, with all the safety risks this entails.

In one embodiment, the method furthermore comprises the following step:

the transaction server setting up and establishes a sandbox environment; and wherein the buyer-identification information and the transaction data for performing the electronic transaction between the buyer and merchant retrieved by the transaction server from the trusted third party of are stored in the sandbox environment.

The use of a sandbox means that the application, the operating system or only the data are stored, executed or present in a virtual closed part of the system. The processes required for this purpose cannot readily interact with the processes and the data outside the sandbox environment. Applications, access to data and processes from outside the sandbox to processes and data in the sandbox is protected. As a result thereof, the sandbox environment prevents manipulation of the buyer identification.

In one embodiment, the method furthermore comprises the step of cancelling the sandbox environment after the life span of the expiration parameter has finished.

For additional security, the expiration parameter may be coupled to the existence of the sandbox. The sandbox may be created at the moment a transaction has to be performed and as soon as the expiration timer has expired, the sandbox will automatically be destroyed, in this case with all the data.

According to a second aspect, the invention provides a computer storage medium, containing stored instructions for performing an electronic transaction between a mobile communication device of a buyer, a terminal of a merchant and a transaction server connected to the terminal, which mobile communication device, the terminal and the transaction server are comprised in a data network, wherein the instructions are designed to perform the following steps:

the mobile communication device initiates a communication session with the transaction server via the terminal;

the transaction server receives an identification code which is related to the buyer from the mobile communication device;

the transaction server initiates a communication session with a trusted third party;

the transaction server retrieves buyer-identification information and transaction data for performing the electronic transaction between the buyer and merchant from the trusted third party;

the transaction server authenticates the buyer on the basis of the received buyer-identification information;

the transaction server processes the electronic transaction between the buyer and merchant; furthermore comprising the following steps:

the mobile communication device transmits an expiration parameter to define a life span of the buyer-identification information on the transaction server together with the identification code to the transaction server;

the transaction server automatically removes the buyer-identification information after the life span of the transaction server determined by the expiration parameter has expired.

Advantages of the second aspect are identical to those of the reversing device according to the present invention.

### DESCRIPTION OF THE FIGURES

The present invention will be described below by means of the figures.

FIG. 1 shows the steps of the method according to the first aspect of the invention.

FIG. 2 shows the system according to the second aspect of the invention.

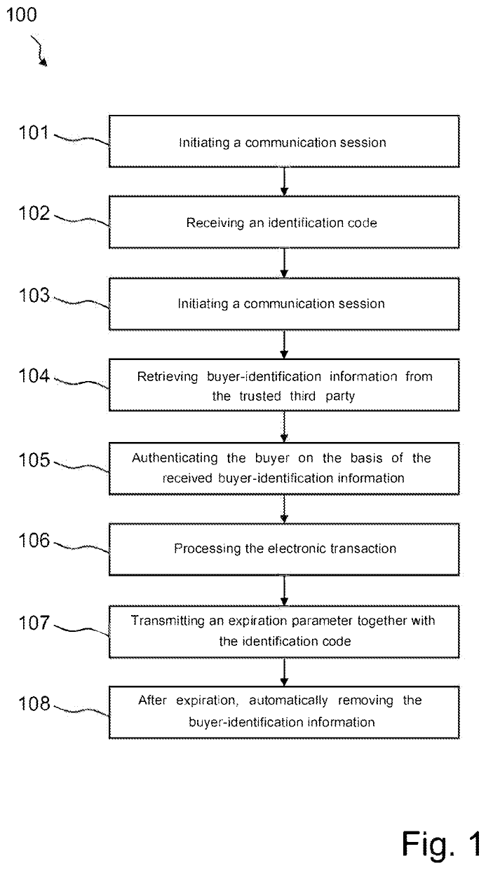

FIG. 1 shows a few steps of the first aspect of the invention 100 for performing an electronic transaction. This consists at least of the following steps 101-108 which are performed in a data network containing three or more nodes. At least one of these nodes is a mobile communication device of a first user, in this case the buyer of a product or a service. In this case, it has to be noted that, in the context of the present description, the transaction may relate to a transaction in which a right to dispose of an item of property is transferred to another party having legal personality, being a person or organization which has legal personalities. This may mean that a person or organization uses, rents, borrows or obtains the ownership of a physical or tangible object from another person or organization, but it may also relate to an intangible item, such as a digital currency unit or a service. Thus, at least one second user is involved in the transaction, being the other party having legal personality. The latter has a terminal at his or her disposal. This terminal may also be a mobile phone, such as a smartphone, just like the mobile communication device of the buyer, but it may also be a dedicated device, such as a payment terminal, cash register system or a different kind of device. At least the terminal is connected to a transaction server. This connection may be partly wired and partly wireless or entirely wired or entirely wireless. The same applies to the connection between the transaction server and a further server, being a server which is recognized as a trusted party by all nodes of the network.

In a first step 101 of the method, the mobile communication device initiates a communication session with the transaction server via the terminal. This communication session is established by means of a preferably symmetrically or asymmetrically encrypted connection. After the connection has been established, the transaction server will receive an identification code from the mobile communication device in step 102. This identification code is related to the buyer. This may be by a non-traceable unique code or by a hash of one or more of the data of the user, such as a hashed username, first name/surname, telephone number, account number or the like. The transaction server then initiates a communication session with a trusted third party in step 103. This party is an entity or node which facilitates the communication session and the safe transfer of data, but most of all confirmation of identities between the smartphone and the transaction server (via the terminal). Both parties, the buyer and the seller or also more generally the merchant (i.e. between smartphone and terminal user) trust this third party and the latter preferably provides all transaction-related and identity-related data between the parties. In the following step 104, the trusted third party will provide identification information to the buyer as well as transaction data to perform the electronic transaction for the communication session between the buyer and seller or merchant.

By means of the data provided by the third party, the buyer, and preferably also the seller, can be authenticated in the following step 105. Now the merchant/seller has authenticated the buyer, and preferably the buyer has authenticated the seller, the actual transaction between the two parties can be performed. To this end, the transaction server will process a transaction 106. This may be in the form of a settlement of a balance between two accounts of the two parties, or by another form of payment or registration. This may thus also be acceptance of a service or the acceptance of a property, without there being a direct monetary payment involved in this transaction. The method furthermore comprises the steps of the mobile communication device transmitting 107 an expiration parameter to define a life span of the buyer-identification information on the transaction server together with the identification code to the transaction server. By means of this expiration parameter, the buyer retains control over access to his or her identity data. Due to the fact that the expiration parameter comprises a time period which will elapse at a certain moment, this configuration will cause the transaction server to automatically remove the available buyer-identification information in the last step 108. Now the buyer-identification information has automatically been removed from the transaction server, this information has only been made available for and during the period of the transaction. Thereafter, this information is only present again on the trusted third party. This simplifies executing transactions between buyers and merchants without in this case an infrastructure having to be provided to safely manage the information required for the transaction. In addition, the buyer retains control at all times over his or her personal information and thus privacy-sensitive data. Therefore, the merchant does not have to make any arrangements to secure and manage the data because he or she no longer has the privacy-sensitive data.

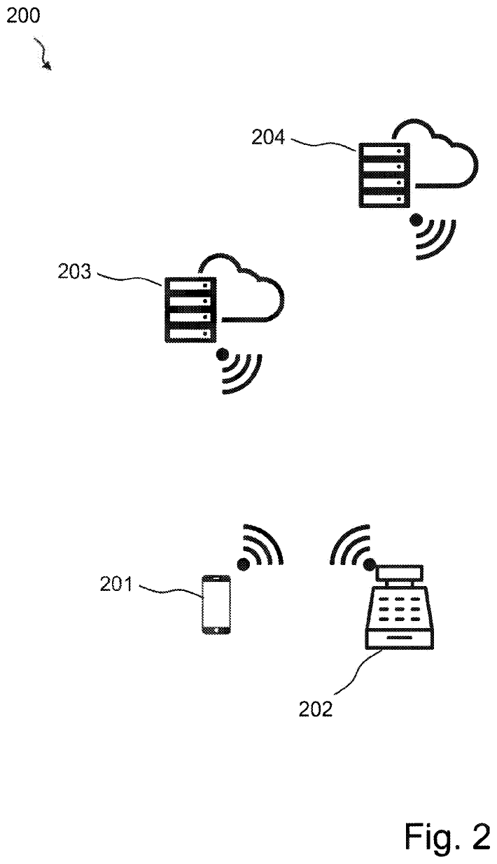

FIG. 2 shows the various components of the system. The system 200 shows a device of the buyer 201, in this case a mobile communication device in the form of a smartphone. The smartphone 201 is in direct contact with the terminal 202 of the merchant. In FIG. 2, this terminal is configured in the form of a cash register system 202, but this may also be a dedicated device, or a smartphone, tablet, computer or the like. The terminal 202, but preferably also the smartphone 201 are in wired, but preferably wireless, contact with the transaction server 203. The latter is under the control of a service provider which allows the merchant to facilitate transactions electronically. The transaction server 203 is preferably situated in a datacenter or in another remote location. The transaction server is capable of establishing a connection to a second server 204, which is a trusted third-party server which is able to check, control and provide the identity of at least one or more of the buyer, merchant and service provider.

1. A method for performing an electronic transaction between a mobile communication device of a buyer, a terminal of a merchant and a transaction server which is connected to the terminal, which mobile communication device, the terminal and the transaction server are comprised in a data network, the method comprising the following steps:
the mobile communication device initiates a communication session with the transaction server via the terminal;
the transaction server of the mobile communication device receives an identification code which is linked to the buyer;
the transaction server initiates a communication session with a trusted third party;
the transaction server retrieves buyer-identification information and transaction data from the trusted third party in order to perform the electronic transaction between the buyer and merchant;
the transaction server authenticates the buyer on the basis of the received buyer-identification information;
the transaction server processes the electronic transaction between the buyer and merchant; furthermore comprising the following steps:
the mobile communication device transmits an expiration parameter to define a life span of the buyer-identification information on the transaction server together with the identification code to the transaction server;
the transaction server automatically removes the buyer-identification information after the life span of the transaction server determined by the expiration parameter has expired.

2. The method for performing an electronic transaction as claimed in claim 1, wherein the expiration parameter is encrypted by the mobile communication device of the buyer.

3. The method for performing an electronic transaction as claimed in claim 1, furthermore comprising the following step:
the transaction server up establishes a sandbox environment; and wherein the buyer-identification information and the transaction data for performing the electronic transaction between the buyer and merchant retrieved by the transaction server from the trusted third party of are stored in the sandbox environment.

4. The method for performing an electronic transaction as claimed in claim 3, wherein the sandbox environment is cancelled after the life span of the expiration parameter has finished.

5. A non-transitory computer readable medium, containing stored instructions for performing an electronic transaction between a mobile communication device of a buyer, a terminal of a merchant and a transaction server connected to the terminal, which mobile communication device, the terminal and the transaction server are comprised in a data network, wherein the instructions are executed by one or more processors to perform the following steps:
the mobile communication device initiates a communication session with the transaction server via the terminal;
the transaction server receives an identification code which is related to the buyer from the mobile communication device;
the transaction server initiates a communication session with a trusted third party;
the transaction server retrieves buyer-identification information and transaction data for performing the electronic transaction between the buyer and merchant from the trusted third party;
the transaction server authenticates the buyer on the basis of the received buyer-identification information;
the transaction server processes the electronic transaction between the buyer and merchant; furthermore comprising the following steps:
the mobile communication device transmits an expiration parameter to define a life span of the buyer-identification information on the transaction server together with the identification code to the transaction server;
the transaction server automatically removes the buyer-identification information after the life span of the transaction server determined by the expiration parameter has expired.
